(19) United States
(12) Patent Application Publication
(10) Pub. No.: US 2009/0185084 A1
(43) Pub. Date: Jul. 23, 2009

(54) Projection Apparatus and Signal Converting Module Thereof

(75) Inventors: Yi An CHEN, Taoyuan Hsien (TW); Bill CHEN, Taoyuan Hsien (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: Delta Electronics, Inc., Taoyuan Hsien (TW)

(21) Appl. No.: 12/110,472

(22) Filed: Apr. 28, 2008

(30) Foreign Application Priority Data
Jan. 21, 2008 (TW) 097102173

(51) Int. Cl. H04N 9/31; H04N 7/01

(52) U.S. Cl. 348/744; 348/441; 348/E07.003; 348/E09.025

(57) ABSTRACT

A projection apparatus and a signal converting module thereof are provided. The projection apparatus comprises an output module and a signal converting module. The output module outputs at least one signal in a first format. The signal converting module comprises a receiving unit, a processing unit, and an interface unit. The receiving unit receives at least one first signal in a second format. The processing unit converts the at least one first signal into at least one second signal in the first format. The interface unit is configured to transmit the at least one second signal to the output module, while the output module is configured to output the at least one second signal in the first format.

This application claims the benefit of priority based on Taiwan Patent Application No. 097102173, filed on Jan. 21, 2008, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a projection apparatus and a signal converting module thereof. More particularly, the present invention relates to a projection apparatus adapted to output video signals, audio signals and control signals of different formats through a signal converting module.

2. Descriptions of the Related Art

Traditionally, projectors have been used at office meetings, presentations, or venues of that nature. Over recent years, projectors have made their way into the household appliance market due to its improved definition, reduced manufacturing costs and miniaturization. As a result, there has been a gradual increase in the overall output of projectors, forcing manufacturers to speed up the development of various projectors for different uses. Simultaneously, in an attempt to improve the competitiveness of their products in the projector market, manufacturers have become more concerned about the cost of producing projectors. Furthermore, because projectors comprise elements involving various technical fields such as electric machinery, electronics, mechanical mechanisms, optics and thermal flux, functional improvement or alteration to a projector will inevitably cause a structural change to these elements.

In the conventional technologies for manufacturing projectors, when a change is made to the internal structure of a projector to meet cost and functional requirements, the number of internal input/output (I/O) interfaces needed for the associated functions often has to be changed accordingly. Furthermore, because projectors have a limited interior space, an increased number of I/O interfaces will inevitably have an influence on the basic structure of the projector which almost has no flexibility to accommodate such an increase. Consequently, the functional alteration of a projector typically imposes a strong influence on the overall projector structure, and requires structural redesigns.

For instance, if the heat dissipation of a projector requires an increase in the number of cooling fans from three to five, the amount of wires used for the associated interfaces (e.g., a power supply interface) or the number of pins in the sockets has to be altered accordingly. Another instance is a projector originally merely comprising a D-sub connector for an input interface of analog video signals. If a high-definition multimedia interface (HDMI) which is widely used for digital video signals is to be added to the projector which originally merely comprises a D-sub connector for analog video signals, modules or a processor for processing video signals have to be redesigned accordingly as well. As a consequence, the commonality between the original and the redesigned projector is eliminated, which implies an extension for the developing period and a rising manufacturing cost of the projector. In conclusion, the redesign of the projector may have an adverse effect on the quality of the product.

To summarize, efforts still have to be made by projector manufacturers to provide a method capable of minimizing the need to redesign and shorten the product development period when a functional alteration is made to a projector.

### SUMMARY OF THE INVENTION

An objective of this invention is to provide a projection apparatus and a signal converting module thereof. The projection apparatus comprises an output module and a signal converting module. The output module is configured to output at least one signal in a first format. The signal converting module comprises a receiving unit, a processing unit and an interface unit. The receiving unit is configured to receive at least one first signal in a second format. The processing unit is configured to convert the at least one first signal into at least one second signal in the first format. The interface unit is configured to transmit the at least one second signal to the output module to output the at least one second signal in the first format.

This invention improves the commonality of a projector by using a signal converting module. The signal converting module may accept changes to its structure or wiring scheme changed according to the different signals that it receives. The interface unit thereof is capable of converting the different signals into signals of a uniform specification. In this way, a structural change to the signal converting module will not influence the design of the projection apparatus as a whole, and thus, the signal converting module can accept changes or additions to its functions according to any requirements. As a result, any changes to the projection apparatus that may have caused problems in the projection apparatus of the prior art will be eliminated.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating a preferred embodiment of this invention.

### DESCRIPTION OF THE PREFERRED EMBODIMENT

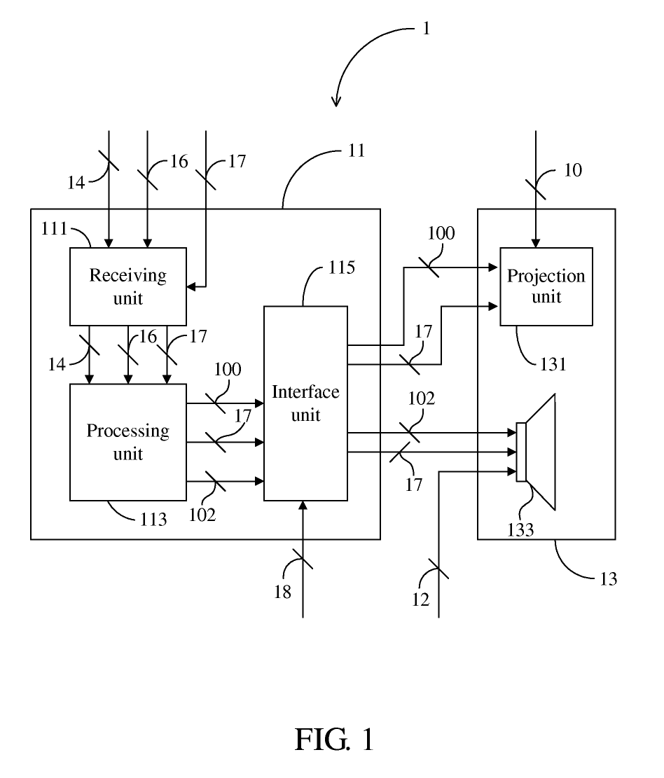

FIG. 1 illustrates a preferred embodiment of this invention, which is a projection apparatus 1 comprising a signal converting module 11 and an output module 13. The output module 13 further comprises a projection unit 131 with an application-specific integrated circuit (ASIC) for digital light processing (DLP) and a loudspeaker 133 configured to output sound signals. The output module 13 is originally configured to receive and output a signal in a first format. For example, the projection unit 131 is configured to output a video signal 10 in an analog format (e.g., an RGB video signal), while the loudspeaker 133 is configured to output an audio signal 12 in an analog format.

The signal converting module 11 comprises a receiving unit 111, a processing unit 113 and an interface unit 115. The interface unit 115 comprises signal pins for various purposes, by which the signal converting module 11 is interfaced with the output module 13. It should be noted that these signal pins may include ones configured to receive a power supply 18 on which the signal converting module 11 operates, ones adapted to transmit a video signal 10 in an analog format, ones adapted to transmit an audio signal 12 in an analog format, or ones configured to transmit a control signal (e.g., an RS-232 signal). On the other hand, the receiving unit 111 is configured to receive first signals in other formats, for example, video signals 14 transmitted in an Internet packet or HDMI format, or audio signals 16 transmitted in an Internet packet or HDMI format. Additionally, the receiving unit 111 may also receive a signal 17 unnecessary for format conversion, for example, an S-Video signal in an analog format, an audio signal in an analog format, or a control signal in a USB format, an RS-485 format or an RS-232 format. When receiving a first signal in one of the aforesaid other formats (e.g., the video signal 14 and the audio signal 16 transmitted in the HDMI format), the processing unit 13 converts the first signal into a second signal in the first format (i.e., the analog format) and then transmits to the interface unit 115 afterward. On the other hand, upon receipt of a signal 17, the processing unit 113 directly transmits the signal 17 to the interface unit 115.

More specifically, to mitigate the interference from the power supply 18, signal pins and power supply 18 pins are arranged separately in the interface unit 115. The processing unit 113 transmits the signal 17 unnecessary for format conversion to the interface unit 115 directly, and converts the video signal 14 transmitted in the HDMI format into a video signal 100 in the analog format adapted to be outputted from the projection unit 131. The audio signal 16, transmitted in the HDMI format, is converted into an audio signal 102 in the analog format adapted to be outputted from the loudspeaker 133. Then, the signals which have been converted into the first format (i.e., the analog format) are transmitted by the signal converting module 11 via the interface unit 115 and the signal pins thereof to the output module 13 for playing. On the other hand, the signal 17 unnecessary for format conversion is transmitted via the interface unit 115 and the signal pins thereof to the output module 13 for playing (such as an S-Video signal in the analog format or an audio signal in the analog format), or transmitted to other processing units of the projection apparatus 1 for other operations (such as a control signal in the USB format, the RS-485 format or the RS-232 format).

Although a video and an audio signal transmitted in the HDMI format is preferred to be received by the receiving unit 111 and converted by the processing unit 113 into a video and an audio signal in the analog format adapted to be played by the output module 13, this invention is not limited to the reception of merely two second signals in other formats (i.e., the video signal 14 and the audio signal 16 transmitted in the HDMI format). Instead, according to this invention, only one or more than two second signals in other formats may also be received for signal conversion as described in the above paragraph, for example, video signals, audio signals or control signals in various other formats. The processing unit 113 may rely on an internal switch (not shown) to select a signal (signals) to be outputted to the output module 13. The process of performing the signal conversion by the signal converting module 11 and outputting the converted signal to the output module 13 for playing or use in other embodiments will readily occur to those of ordinary skill in the art upon reviewing the aforementioned preferred embodiment, and thus will not be further described herein.

It follows from the above description that by using a signal converting module, this invention is capable of converting different signals into signals in a uniform format for output. Furthermore, the signal converting module may have its structure or wiring scheme changed according to different video, audio or control signals. Besides, the signal converting module 11 enables a sure separate transmission of the control signals, video signals, audio signals and the power supply, thus mitigating possible interferences between and enlarging the current flow of the power supply. Thus, the projection apparatus of this invention allows its functions to be altered or added without altering the overall structure and internal design thereof, thus permitting the implementation of diversified projection products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signal converting module for use in a projection apparatus, the projection apparatus further comprising an output module, being configured to output at least one signal in a first format, the signal converting module comprising:
a receiving unit being configured to receive at least one first signal in a second format;
a processing unit being configured to convert the at least one first signal into at least one second signal in the first format; and
an interface unit being configured to transmit the at least one second signal to the output module;
wherein the output module outputs the at least one second signal in the first format.

2. The signal converting module as claimed in claim 1, wherein the interface unit receives a power source to furnish the signal converting module to operate.

3. The signal converting module as claimed in claim 1, wherein the at least one first signal is one of a video signal, an audio signal, and a control signal.

4. The signal converting module as claimed in claim 1, wherein the at least one second signal is one of a video signal, an audio signal, and a control signal.

5. The signal converting module as claimed in claim 1, wherein the first format is an analog format.

6. The signal converting module as claimed in claim 1, wherein the second format is one of an analog format, a digital format, and an internet packet format.

7. A projection apparatus, comprising:
an output module being configured to output at least one signal in a first format; and
a signal converting module being configured to receive at least one first signal in a second format, to convert the at least one first signal to at least one second signal in the first format, and to transmit the at least one second signal to the output module;
wherein the output module outputs the at least one second signal in the first format.

8. The projection apparatus as claimed in claim 7, wherein the signal converting module comprises:
a receiving unit being configured to receive the at least one first signal;
a processing unit being configured to convert the at least one first signal to the at least one the second signal; and
an interface unit being configured to transmit the at least one second signal to the output module.

9. The projection apparatus as claimed in claim 8, wherein the interface unit receives a power source to furnish the signal converting module to operate.

10. The projection apparatus as claimed in claim 7, wherein the at least one first signal is one of a video signal, an audio signal, and a control signal.

11. The projection apparatus as claimed in claim 7, wherein the at least one second signal is one of a video signal, an audio signal, and a control signal.

12. The projection apparatus as claimed in claim 7, wherein the first format is an analog format.

13. The projection apparatus as claimed in claim 7, wherein the second format is one of an analog format, a digital format, and an internet packet format.
